(19) United States
(12) Patent Application Publication
(10) Pub. No.: US 2014/0044854 A1
(43) Pub. Date: Feb. 13, 2014

(54) CREAMERS AND METHODS OF MAKING SAME

(71) Applicants: Jean-Baptiste Bezelgues, Powell, OH (US); J. Antonio Gutierrez, Dublin, OH (US); Martin Erwin Leser, Dublin, OH (US)

(72) Inventors: Jean-Baptiste Bezelgues, Powell, OH (US); J. Antonio Gutierrez, Dublin, OH (US); Martin Erwin Leser, Dublin, OH (US)

(73) Assignee: NESTEC S.A., Vevey (CH)

(21) Appl. No.: 14/114,435

(22) PCT Filed: Apr. 30, 2012
(86) PCT No.: PCT/EP12/57891

§ 371 Date: Oct. 28, 2013

Related U.S. Application Data
(60) Provisional application No. 61/480,816, filed on Apr. 29, 2011.

(51) Int. Cl. A23C 13/14

(52) U.S. Cl. CPC A23C 13/14
USPC 426/583; 426/586; 426/584

(57) ABSTRACT

Creamers for whitening food products are provided. The creamers can have long-term stability, high whitening capacity and a pleasant mouth feel. In a general embodiment, the present disclosure provides a natural dairy creamer including a sugar, a fat, a protein having a globular protein denaturation degree between about 75% and about 98%, and a viscosity ranging between about 10 cP and about 70 cP when measured at a temperature of 4° C. and a shear rate of 75 s⁻¹.

### BACKGROUND

The present disclosure generally relates to food products. More specifically, the present disclosure relates to creamers for food products such as coffee and tea.

Creamers are widely used as whitening agents with hot and cold beverages, e.g., coffee, cocoa, tea, etc. They are commonly used in place of milk and/or dairy cream. Creamers may come in a variety of different flavors and provide a whitening effect, mouthfeel, body, and a smoother texture.

Creamers can be in liquid or powder forms. One disadvantage of powder forms is that they do not generally provide an impression of traditional dairy creamers. Another disadvantage of using powder creamers may include difficulties in dissolution when added to coffee, and also the possibility of having a non-homogeneous beverage.

More and more consumers are concerned by the naturalness of food products. Thus, there is a demand for commercially available natural creamers. Usually non-dairy creamers contain stabilizers such as carrageenan, cellulose gums, cellulose gels, synthetic emulsifiers, or buffer salts or whitening agents that are all not perceived as natural by the consumer. These artificially perceived food ingredients, however, are typically needed to guarantee the physical stability of the non-dairy creamer over the shelf life of the product and after pouring into coffee in order to achieve their desired whitening effect in the coffee. In the absence of these ingredients, the coffee creamers are much less stable over time and show less whitening and adverse sensorial effects. This means that without the addition of emulsifiers and stabilizers, the conventional non-dairy creamers cannot be stored up to 6 months shelf-life without severe physical destabilization occurring.

Currently, “pseudo natural creamers” exist, which are dairy or non-dairy based but still contain either hydrocolloids as stabilizers, emulsifiers or buffer salts, chelators such as dipotassium phosphate, sodium citrate and sometime artificial and natural flavor combinations. Although these pseudo natural creamers are touted as being natural, they are usually not completely natural.

Half and half can be considered as a natural dairy creamer but it does not sweeten or flavor the coffee. Furthermore, the mouth feeling and masking of the coffee by half and half coffee creamers is significantly weaker than artificial whiteners. Therefore, there is a need for natural creamers having long-term stability along with excellent whitening and sensorial properties.

### SUMMARY

The present disclosure relates to creamers for food products and methods of making the creamers. The creamers can be stored at room temperature or chilled and be stable for extended periods of time. The creamers can have high whitening capacity and a pleasant mouthfeel while masking the bitterness and astringency of a beverage. In a general embodiment, the present disclosure provides a creamer including a sugar, a fat, a protein having a globular protein denaturation degree between about 75% and about 98%, and a viscosity ranging between about 10 cP and about 70 cP when measured at a temperature of 4° C. and a shear rate of 75 s⁻¹.

Embodiments of the present disclosure provide natural, dairy-based, liquid creamers that do not need to contain any stabilizers, synthetic emulsifiers, buffer salts or artificial whitening agents, but which can be stable for 6 months or longer at about 4° C. and provide a good whitening effect in beverages, for example, such as coffee. This can be achieved by increasing the viscosity in the creamer, for example, by modulating the denaturation degree of the proteins present in the creamer as a function of the sugar content. The observed effect is similar to the addition of stabilizers or emulsifiers to the creamer.

In another embodiment, the present disclosure provides a creamer comprising a sugar, a fat, a protein having a globular protein denaturation degree between about 75% and about 98%, and a viscosity ranging between about 7 cP and about 70 cP when measured at a temperature of 20° C. and a shear rate of 75 s⁻¹.

In any embodiments of the creamer, the viscosity of the creamer ranges between about 11 cP and about 40 cP when measured at a temperature of 4° C. and a shear rate of 75 s⁻¹. In another embodiment, the viscosity of the creamer ranges between about 12 cP and about 16 cP when measured at a temperature of 4° C. and a shear rate of 75 s⁻¹. The creamer can include a sugar:protein mass ratio ranging from about 10:1 to about 18:1.

In any embodiments of the creamer, the sugar can be one or more of monosaccharides, disaccharides, trisaccharides, polysaccharides (e.g., maltodextrin) or a combination thereof from a sugar source such as, for example, beets, canes, condensed milk, honey, molasses, agave syrup, maple syrup, malt, corn, tapioca, potato or a combination thereof. In an embodiment, the protein can be from a protein source including at least one of liquid cow milk, soy milk, heavy cream, buttermilk, chocolate milk, condensed milk, evaporated milk, rice flour, whey protein microgels, soy protein powder, whole milk powder, non fat dry milk powder or a combination thereof. In another embodiment, the fat can be from a fat source including at least one of heavy cream, liquid whole milk, partially defatted liquid milk, whole milk powder, anhydrous milk fat or a combination thereof. The creamer can further include any other suitable ingredients such as flavors, sweeteners and/or colorants.

In another embodiment, the present disclosure provides a natural dairy creamer including between about 12% and about 35% by mass of sugar, between about 2.5% and about 12% by mass of a fat, about 1% and about 5% by mass of a protein having a globular protein denaturation degree between about 75% and about 98% (e.g., based on the total protein content of the creamer), and a viscosity ranging between about 10 cP and about 70 cP when measured at a temperature of 4° C. and a shear rate of 75 s⁻¹. In this embodiment, the natural dairy creamer excludes hydrocolloids, synthetic emulsifiers, buffer salts and artificial whitening agents.

In an embodiment of the natural dairy creamer, the viscosity ranges between about 11 cP and about 40 cP when measured at a temperature of 4° C. and a shear rate of 75 s⁻¹. In an embodiment of the natural dairy creamer, the viscosity ranges between about 12 cP and about 16 cP when measured at a temperature of 4° C. and a shear rate of 75 s⁻¹.

In another embodiment, the present disclosure provides a natural dairy creamer comprising between about 12% and about 35% by mass of sugar, between about 2.5% and about 12% by mass of a fat, and about 1% and about 5% by mass of a protein having a globular protein denaturation degree between about 75% and about 98%. The natural dairy creamer may exclude hydrocolloids, synthetic emulsifiers, buffer salts and artificial whitening agents.

In any embodiments of the natural dairy creamer, the sugar can be one or more of monosaccharides, disaccharides, trisaccharides, polysaccharides (e.g., maltodextrin) or a combination thereof from a sugar source such as, for example, beets, canes, condensed milk, honey, molasses, agave syrup, maple syrup, malt, corn, tapioca, potato or a combination thereof. In an embodiment of the natural dairy creamer, the protein can be from a protein source including at least one of liquid cow milk, soy milk, heavy cream, buttermilk, chocolate milk, condensed milk, evaporated milk, rice flour, whey protein microgels, soy protein powder, whole milk powder, non fat dry milk powder or a combination thereof.

In any embodiments of the natural dairy creamer, the fat ranges between about 4% and 10.5% by mass. The fat can be from a fat source including at least one of heavy cream, liquid whole milk, partially defatted liquid milk, whole milk powder, anhydrous milk fat or a combination thereof. The natural dairy creamer can further include any additional suitable ingredients such as flavors, sweeteners and/or colorants.

In another embodiment, the present disclosure provides a consumable product including at least one of a coffee, tea or cocoa, and a creamer including a sugar, a fat, a viscosity ranging between about 10 cP and about 70 cP when measured at a temperature of 4° C. and a shear rate of 75 s⁻¹, and a protein having a globular protein denaturation degree between about 75% and about 98%. In an embodiment, the viscosity of the creamer can range between about 11 cP and about 40 cP when measured at a temperature of 4° C. and a shear rate of 75 s⁻¹. The viscosity of the creamer can further range between about 12 cP and about 16 cP when measured at a temperature of 4° C. and a shear rate of 75 s⁻¹.

In an embodiment of the consumable product, the sugar can be from a sugar source including at least one of beets, canes, condensed milk, honey, molasses, agave syrup, maple syrup, malt, corn, tapioca, potato or a combination thereof. In an embodiment of the consumable product, the protein can be from a protein source including at least one of liquid cow milk, soy milk, heavy cream, buttermilk, chocolate milk, condensed milk, evaporated milk, rice flour, whey protein microgels, soy protein powder, whole milk powder, non fat dry milk powder or a combination thereof.

In an embodiment of the consumable product, the fat ranges between about 4% and 10.5% by mass of the creamer. The fat can be from a fat source including at least one of heavy cream, liquid whole milk, partially defatted liquid milk, whole milk powder, anhydrous milk fat or a combination thereof.

In an alternative embodiment, the present disclosure provides a method of making a creamer. The method comprises combining a fat, a sugar and a protein to form a mixture having a sugar:protein mass ratio ranging from about 10:1 to about 18:1, and heating the mixture at a temperature ranging from about 45° C. to about 85° C. to achieve a globular protein denaturation degree between about 75% and about 98% to form the creamer. The creamer has a viscosity ranging between about 10 cP and about 70 cP when measured at a temperature of 4° C. and a shear rate of 75 s⁻¹. The method can also comprise homogenizing and aseptically processing the creamer. In an embodiment of the method, the creamer does not include any hydrocolloids, synthetic emulsifiers, buffer salts and artificial whitening agents.

In yet another embodiment, the present disclosure provides a method of making a dairy creamer having a whitening effect. The method comprises combining a sugar, a dairy source having a fat, and a dairy source having a protein to form a dairy mixture having a sugar:protein mass ratio ranging from about 10:1 to about 18:1 and heating the dairy mixture at a temperature ranging from about 45° C. to about 85° C. to achieve a globular protein denaturation degree between about 75% and about 98% to form the dairy creamer. The dairy creamer has a viscosity ranging between about 10 cP and about 70 cP when measured at a temperature of 4° C. and a shear rate of 75 s⁻¹. The dairy creamer can be further subjected to ultra high temperature sterilization.

In an embodiment of the method, the dairy source having the fat and the dairy source having the protein are pasteurized before being combined with the sugar. The dairy source having the fat and the dairy source having the protein can be the same dairy source or each be from one or more different dairy sources. In an embodiment of this method, the dairy creamer does not include any hydrocolloids, synthetic emulsifiers, buffer salts and artificial whitening agents.

An advantage of the present disclosure is to provide a natural creamer having a high whitening capacity without using artificial ingredients.

Another advantage of the present disclosure is to provide a natural, dairy-based, liquid creamer that does not include any hydrocolloids, synthetic emulsifiers, buffer salts and artificial whitening agents.

Yet another advantage of the present disclosure to provide a long-term, stable creamer having excellent whitening effects that is stable for at least 6 months at a temperature of about 4° C.

Still another advantage of the present disclosure to provide a long-term, stable creamer having excellent whitening effects that is stable for at least 4 months at a temperature of about 20° C. to about 25° C.

Another advantage of the present disclosure is to provide a liquid creamer that has a good mouthfeel, body, smooth texture, and a good flavor without off-notes.

Additional features and advantages are described herein, and will be apparent from, the following Detailed Description and the figures.

### BRIEF DESCRIPTION OF THE FIGURES

FIG. 1 shows the kinetic of creaming in different dairy creamer measured using a Lumisizer at 4° C., 4000 g. Creamers 1 and 2 are conventional dairy creamers. Creamer 3 is formulated according to embodiments of the present disclosure.

FIG. 2 shows the effect of temperature on viscosity for different dairy creamer products. The viscosities were measured by an Anton Paar Physica MCR 501 rheometer equipped with a double gap concentric cylinder geometry using standard measuring protocols at constant shear rate of 75 s⁻¹ and temperature ranging from 4° C. to 40° C. Creamer 3, 4, 5 are formulated according to embodiments of the present disclosure. Creamers 1 and 2 are conventional dairy creamers.

### DETAILED DESCRIPTION

The present disclosure relates to creamers and methods of making the creamers. The creamers can be in a liquid form and added to any suitable beverage in an amount sufficient to provide a whitening or creaming effect on the beverage. A creaming effect imparts qualities associated with cream or dairy such as desirable, flavor, texture, body, and/or color (e.g., lightening or whitening). In alternative embodiments, the creamers are natural, dairy-based, stable creamers that can include a combination of milk (skim or whole), heavy cream, sugar and a natural flavor. The fat, protein and sugar in the creamer can all come from natural sources. The creamer possesses an adequate shelf life or refrigerated stability and has excellent heat stability not causing unfavorable phenomena such as feathering, oil off, aggregation or cream separation, for example, after addition to a hot beverage such as coffee or tea.

As used herein, the term “stable” means remaining in a state or condition having minimal phase separation (e.g., creaming, sedimentation, age gelation) or spoilage or bitterness (e.g., due to storage) for an extended period of time (e.g., for at least 3, 4, 5, 6 or more months) depending on the storage conditions. Creamers according to certain embodiments of the present disclosure can be stable when maintained for at least 6 months, for example, at refrigeration temperatures (e.g., about 4° C.). For example, such creamers can be in a non-aseptic, refrigerated form (i.e., extended shelf life (“ESL”)) or other suitable forms. Creamers according to other embodiments of the present disclosure can be found to be stable when maintained for at least 4 months, for example, at room temperatures (e.g., about 20° C. to 25° C.). For example, such creamers can be in an aseptic form or other suitable forms.

In a general embodiment, the present disclosure provides creamers including a sugar, a fat, a protein having a globular protein denaturation degree between about 75% and about 98%, and a viscosity ranging between about 10 cP (centipoise) and about 70 cP when measured at a temperature of 4° C. and a shear rate of 75 s⁻¹. The creamers in embodiments of the present disclosure differ from conventional dairy creamers in that they do not need to (although they could) contain any hydrocolloids (e.g., cellulose, microcrystalline cellulose, carboxy-methyl cellulose, carrageenan, agar-agar, cornstarch, gelatin, gellan, guar gum, gum arabic, kojac, locust bean gum, methyl cellulose, pectin, sodium alginate, tapioca maltodextrin, tracaganth, xanthan, etc.), synthetic emulsifiers (e.g., monoglycerides, succinic acid esters of monoglycerides, diacetyl tartaric acid esters of monoglycerides, etc.), buffer salts (e.g., monophosphates, diphosphates, sodium mono- and bicarbonates, potassium mono- and bicarbonates, etc.) and artificial whitening agents (e.g., titanium dioxide, etc.) that are usually used to achieve the desired shelf-life stability and performance (e.g., whitening properties) of dairy or non-dairy based creamers. Although the creamers in embodiments of the present disclosure do not need to contain any artificial additives (e.g., hydrocolloids, thickeners, stabilizers), the creamers are able to exhibit similar or superior stability or whitening power than respective conventional dairy creamers containing artificial additives.

It has been surprisingly found that the exceptional shelf-life and whitening effects of the creamers in embodiments of the present disclosure are related, in part, to the increased viscosity of the creamers as compared to conventional dairy creamers. The increased viscosity of the creamers can be linked to the denaturation degree of globular proteins present in the milk or in the cream, e.g., whey proteins in milk or cream from a cow that is used in the creamers at a given sugar/protein ratio in the creamers. For example, at a sucrose/protein mass ratio of 10.5, the measured denaturation degree of a creamer is 77% and the viscosity (measured at 4° C. and a shear rate of 75 s⁻¹) is 11.0 cP. At higher sucrose/protein mass ratios, for instance of 13.4, the denaturation degree of the creamers is 87% and the viscosity (measured at 4° C. and a shear rate of 75 s⁻¹) is 14.2 cP. As used herein, the term “mass” can also be considered equivalent to “weight” where appropriate.

Generally, the higher the sugar content is in the creamers, the higher is the denaturation degree of the globular proteins, and the higher also is the measured viscosity in the creamers. Typically, the viscosity of the creamers of the present disclosure can be 10%-200% higher than in conventional dairy creamers. Accordingly, the superior viscosities measured in the creamers according to embodiments of the present disclosure compared to the viscosities measured in conventional dairy creamers can be related to an increased denaturation degree of the globular proteins in the creamers.

In any embodiments of the creamer of the present disclosure, the viscosity of the creamer can range between about 10 cP and about 70 cP (e.g., measured at 4° C. at 75 s⁻¹). More specifically, the viscosity of the creamer can be about 10 cP, 11 cP, 12 cP, 13 cP, 14 cP, 15 cP, 16 cP, 17 cP, 18 cP, 19 cP, 20 cP, 21 cP, 22 cP, 23 cP, 24 cP, 25 cP, 26 cP, 27 cP, 28 cP, 29 cP, 30 cP, 31 cP, 32 cP, 33 cP, 34 cP, 35 cP, 36 cP, 37 cP, 38 cP, 39 cP, 40 cP, 41 cP, 42 cP, 43 cP, 44 cP, 45 cP, 46 cP, 47 cP, 48 cP, 49 cP, 50 cP, 51 cP, 52 cP, 53 cP, 54 cP, 55 cP, 56 cP, 57 cP, 58 cP, 59 cP, 60 cP, 61 cP, 62 cP, 63 cP, 64 cP, 65 cP, 66 cP, 67 cP, 68 cP, 69 cP, 70 cP and the like. It should be appreciated that any two amounts of the viscosity recited herein can further represent end points in a preferred range of the viscosity. For example, the amounts of 11 cP and 40 cP can represent the individual viscosities of the creamer as well as a preferred range of the viscosities in the creamer ranging between about 11 cP and about 40 cP.

The protein denaturation of the proteins from the protein source can be achieved by any suitable process that causes denaturing of the globular proteins in the creamer. Such process can be, for example, homogenization, direct heating by steam infusion or injection, indirect heat treatment through tubular exchanger, ultrasound, high pressure treatment or any combinations of thereof.

In any embodiments of the creamer of the present disclosure, the protein denaturation degree of the creamer can range between about 75% and about 98% (e.g., based on the total protein content). More specifically, the protein denaturation degree can be about 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98% and the like. It should be appreciated that any two amounts of the protein denaturation degree recited herein can further represent end points in a preferred range of the protein denaturation degree. For example, the amounts of 77% and 87% can represent the individual protein denaturation degrees of the proteins in the creamer as well as a preferred range of the protein denaturation degree in the creamer ranging between about 77% and about 87%.

In any embodiments of the creamer of the present disclosure, the sugar:protein mass ratio of the creamer (e.g., during the protein denaturation process) can range between about 10:1 and 18:1. More specifically, the sugar:protein mass ratio can be about 10:1, 10.5:1, 11:1, 11.5:1, 12:1, 12.5:1, 13:1, 13.5:1, 14:1, 14.5:1, 15:1, 15.5:1, 16:1, 16.5:1, 17:1, 17.5:1, 18:1 and the like. It should be appreciated that any two amounts of the sugar:protein mass ratio recited herein can further represent end points in a preferred range of the sugar:protein mass ratio. For example, the amounts of 13.5:1 and 16:1 can represent the individual sugar:protein mass ratios in the creamer as well as a preferred range of the sugar:protein mass ratio in the creamer ranging between about 13.5:1 and about 16:1.

In any embodiments of the creamer of the present disclosure, the sugar (e.g., sucrose, monosaccharides, disaccharides, trisaccharides, polysaccharides, etc.) can be from any suitable sugar source. Non-limiting examples of the sugar source include beets, canes, condensed milk, honey, molasses, agave syrup, maple syrup, malt, corn, tapioca, potato or a combination thereof. In any embodiments of the creamer of the present disclosure, the amount of sugar in the creamer can range between about 12% and about 35% by mass. More specifically, the sugar can be about 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% by mass and the like. It should be appreciated that any two amounts of the sugar recited herein can further represent end points in a preferred range of the sugar. For example, the amounts of 20% and 25% by mass can represent the individual amounts of the sugar in the creamer as well as a preferred range of the sugar in the creamer ranging between about 20% and about 25% by mass.

In any embodiments of the creamer of the present disclosure, the protein can be from a protein source such as liquid cow milk, soy milk, heavy cream, buttermilk, chocolate milk, condensed milk, evaporated milk, rice flour, whey protein microgels, soy protein powder, whole milk powder, non fat dry milk powder or a combination thereof. In any embodiments of the creamer of the present disclosure, the amount of protein present in the creamer can range between about 1% and about 5% by mass. More specifically, the protein can be about 1%, 1.2%, 1.4%, 1.6%, 1.8%, 2%, 2.2%, 2.4%, 2.6%, 2.8%, 3%, 3.2%, 3.4%, 3.6%, 3.8%, 4%, 4.2%, 4.4%, 4.6%, 4.8%, 5% by mass and the like. It should be appreciated that any two amounts of the protein recited herein can further represent end points in a preferred range of the protein. For example, the amounts of 2.2% and 4.4% by mass can represent the individual amounts of the protein in the creamer as well as a preferred range of the protein in the creamer ranging between about 2.2% and about 4.4% by mass.

In any embodiments of the creamer of the present disclosure, the fat (e.g., oil) can be from a fat source including at least one of heavy cream, liquid whole milk, partially defatted liquid milk, whole milk powder, anhydrous milk fat or a combination thereof. In any embodiments of the creamer of the present disclosure, the amount of fat in the creamer can range between about 12% and about 35% by mass. More specifically, the fat can be about 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35% by mass and the like. It should be appreciated that any two amounts of the fat recited herein can further represent end points in a preferred range of the fat. For example, the amounts of 20% and 25% by mass can represent the individual amounts of the fat in the creamer as well as a preferred range of the fat in the creamer ranging between about 20% and about 25% by mass.

The creamers in embodiments of the present disclosure can further include any other suitable ingredients such as flavors, sweeteners and/or colorants. Flavors can be, for example, chocolate, hazelnut, caramel, vanilla, etc. Sweeteners can be, for example, stevia extract, Luo Han Guo extract, etc. Usage level of the flavors, sweeteners and colorants will vary greatly and will depend on such factors as the level and type of flavors, sweeteners and colors used and cost considerations.

In another embodiment, the present disclosure provides a natural dairy creamer including between about 12% and about 35% by mass of sugar, between about 2.5% and about 12% by mass of a fat, about 1% and about 5% by mass of a protein having a globular protein denaturation degree between about 75% and about 98%, and a viscosity ranging between about 10 cP and about 70 cP when measured at a temperature of 4° C. and a shear rate of 75 s⁻¹. The natural dairy creamer can exclude artificial ingredients such as hydrocolloids, synthetic emulsifiers, buffer salts and artificial whitening agents.

In another embodiment, the present disclosure provides a consumable product including at least one of a coffee, tea or cocoa, and a creamer including a sugar, a fat, a protein having a globular protein denaturation degree between about 75% and about 98%, and a viscosity ranging between about 10 cP and about 70 cP when measured at a temperature of 4° C. and a shear rate of 75 s⁻¹. In an embodiment, the viscosity of the creamer can range between about 11 cP and about 40 cP. The viscosity of the creamer can further range between about 12 cP and about 16 cP. The consumable product can be sold with the coffee, tea or cocoa separated from the creamer (e.g., packaged separately) or sold already mixed together.

The creamers in alternative embodiments of the present disclosure can be easily dispersible in coffee and stable in hot and cold acidic environments without one or more of the following problems: feathering, breaking emulsion, de-oiling, flocculation and sedimentation. When added to coffee, tea, cocoa or other liquid products, the creamers can provide a high whitening capacity, a good mouthfeel, full body, smooth texture, and also a good flavor with no off-flavor notes developed during storage time. The creamers can be used with other various food products such as cereals, as cream for berries, creamers for soups or in many cooking applications.

In an alternative embodiment, the present disclosure provides a method of making a creamer. The method comprises combining a fat, a sugar and a protein from suitable fat sources, sugar sources and protein sources, respectively, to form a mixture having a sugar:protein mass ratio ranging from about 10:1 to about 18:1, and heating the mixture at a suitable temperature to achieve a globular protein denaturation degree between about 75% and about 98% in the mixture to form the creamer. This provides the creamer with a viscosity ranging between about 10 cP and about 70 cP when measured at a temperature of 4° C. and a shear rate of 75 s⁻¹. The method can also comprise homogenizing and aseptically processing the creamer. In an embodiment of the method, the creamer does not include any hydrocolloids, synthetic emulsifiers, buffer salts and artificial whitening agents.

In yet another embodiment, the present disclosure provides a method of making a dairy creamer having a whitening effect. The method comprises combining a sugar, a dairy source having a fat, and a dairy source having a protein to form a dairy mixture having a sugar:protein mass ratio ranging from about 10:1 to about 18:1 and heating the dairy mixture at a suitable temperature to achieve a globular protein denaturation degree between about 75% and about 98% in the dairy mixture to form the dairy creamer. This provide the dairy creamer with a viscosity ranging between about 10 cP and about 70 cP when measured at a temperature of 4° C. and a shear rate of 75 s⁻¹. The dairy creamer can be further subjected to ultra high temperature sterilization and/or refrigeration.

In any embodiments of the methods disclosed herein, the temperature of the mixtures to achieve a globular protein denaturation degree between about 75% and about 98% can range from about 45° C. to about 85° C. More specifically, the temperature can be about 45° C., 50° C., 55° C., 60° C., 65° C., 70° C., 75° C., 80° C., 85° C. and the like. It should be appreciated that any two temperatures recited herein can further represent end points in a preferred range of the temperature. For example, temperatures of 45° C. and 65° C. can represent the individual temperatures of the mixture as well as a preferred range of the temperature ranging between about 45° C. and about 65° C.

In an embodiment of the method, the dairy source having the fat and the dairy source having the protein are pasteurized (or in a pasteurized form) before being combined with the sugar. The dairy source having the fat and the dairy source having the protein can be the same dairy source or each be from one or more different dairy sources. In an embodiment of this method, the dairy creamer does not include any hydrocolloids, synthetic emulsifiers, buffer salts and artificial whitening agents.

As an example of the method according to an embodiment of the present disclosure, a dairy creamer can be prepared by mixing cream, milk (e.g., skim or whole) and sugar. This dairy mixture can be exposed to a temperature ranges from about 45° C. to about 85° C. for a suitable time (e.g., about 20, 25, 30, 35, 40, 45, 50, 55, 60 or more minutes) to cause protein denaturation. The dairy mixture can then be sterilized by steam injection or infusion, for example, at minimum of about 141° C. for about 5 seconds or any other suitable duration.

In any embodiments of the methods described herein, during processing and production of the creamer, the mixing of any components of the creamers such as proteins/dairy product, fat/dairy product, sugar(s), flavor(s), etc., in water can be done under agitation, with or followed by heat treatment, homogenization, cooling and filling aseptic containers under aseptic conditions. Aseptic heat treatment may use direct or indirect ultra high temperature (“UHT”) processes. UHT processes are known in the art. Examples of UHT processes include UHT sterilization and UHT pasteurization.

Direct heat treatment can be performed by injecting steam water in the emulsion. In this case, it may be necessary to remove excess water, by flashing. Indirect heat treatment can be performed with a heat transfer interface in contact with the emulsion. The homogenization could be performed before and/or after heat treatment. It may be interesting to perform homogenization before heat treatment in order to improve heat transfers in the emulsion, and thus achieve an improved heat treatment. Performing a homogenization after heat treatment usually ensures that the oil droplets in the emulsion have the desired dimension. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 B1 to Taggart, which are incorporated herein by reference.

### EXAMPLES

By way of example and not limitation, the following examples are illustrative of various embodiments of the present disclosure.

### Example 1

The effect of an increased viscosity in the creamer on the long term stability of the creamer can be quantified by accelerated emulsion stability tests. As emulsion products are thermodynamically unstable, their long-term stability can be predicted using analytical centrifugation tests.

In this study, a Lumisizer from L.U.M. GmbH, Berlin Germany was used, which is coupled with the STEP-technology to measure the creaming kinetics in emulsions by means of light transmission measurements as a function of the vial height (“Evaluation of long term stability of model emulsions by multisample analytical centrifugation,” Progr. Colloid Polym Sci (2008) 134: 66-73). The measured creaming and destabilization of the emulsion is based on the fact that the density difference between the dispersed and the continuous phase results in creaming of the oil droplets due to gravity. The advantage of using analytical centrifugation (exerting a centrifugal field to the emulsion) is that the stability of an emulsion can be assessed in less time. The stability of an emulsion can be quantified by calculating the kinetics of creaming from the obtained transmission curves. The higher the ‘kinetics of creaming’ index is, the faster the emulsion is creaming and the lower will be the long-term stability of the emulsion.

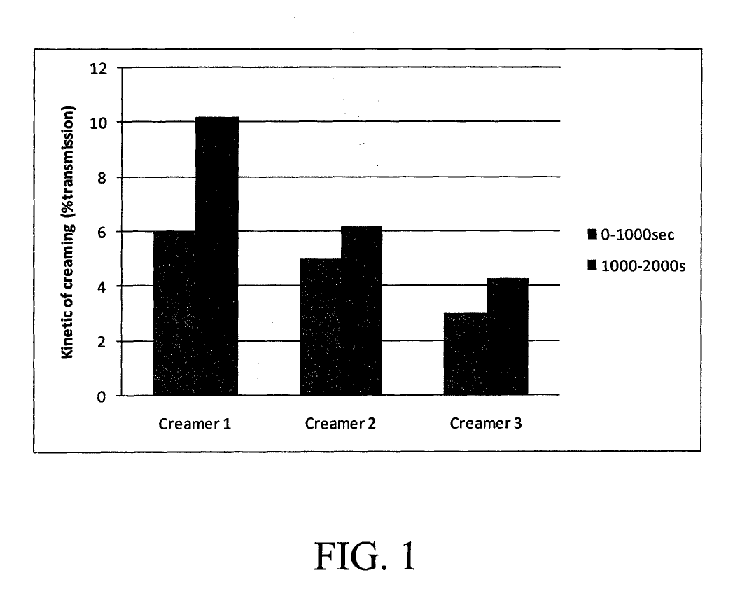

In FIG. 1, the ‘kinetics of creaming’ index of a creamer according to an embodiment of the present disclosure was compared with the ‘kinetics of creaming’ index obtained for two conventional dairy creamers as an example (using a Lumisizer at 4° C., 4000 g). Creamers 1 and 2 are conventional dairy creamers (Creamer 1 is the DARIGOLD® creamer and Creamer 2 is half and half). Creamer 3 is formulated according to embodiments of the present disclosure. As seen in FIG. 1, the kinetics of creaming index is significantly lower in the emulsion of Creamer 3 compared to the emulsions of Creamers 1 and 2. This indicates that the long term stability is predicted to be significantly better for Creamer 3 compared to Creamers 1 and 2. The increased stability of Creamer 3 is due to the higher viscosity in the product.

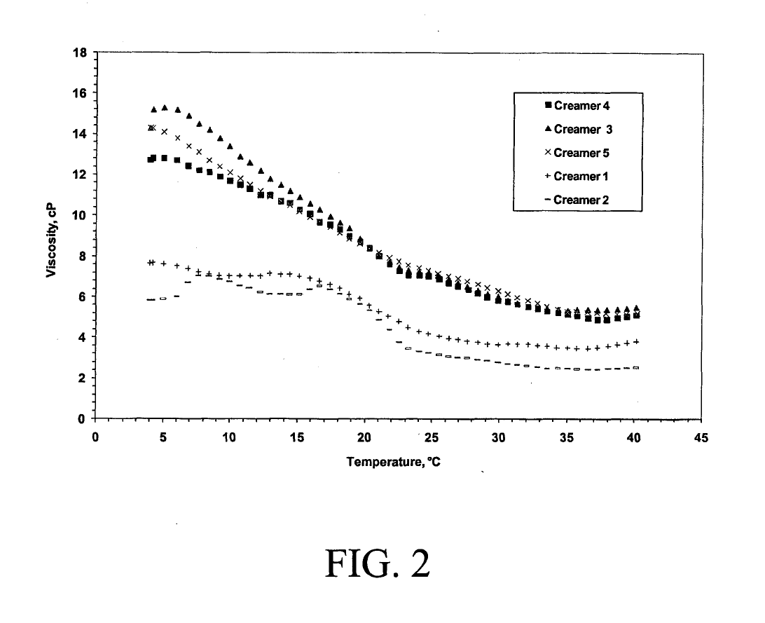

FIG. 2 shows the steady shear viscosity data of different creamers measured at a constant shear rate of 75 s⁻¹ for temperatures from 4° C. till 40° C. The viscosities were measured by means of a Anton Paar Physica MCR 501 rheometer equipped with a double gap concentric cylinder geometry using standard measuring protocols. Creamers 1 and 2 are conventional dairy creamers of FIG. 1. Creamers 3 (same as FIG. 1), 4 and 5 are produced according to formulations of the present disclosure. As seen in FIG. 2, at all temperatures the viscosities of Creamers 3, 4 and 5 are higher than Creamers 1 and 2.

It should be noted that at temperatures between 4° C. and 10° C., i.e., at the temperature of storage of the creamers, Creamers 3, 4 and 5 have a measured viscosity (at a shear rate of 75 s⁻¹) between 10 cP and 16 cP. Depending on the process conditions used, the viscosity can also be higher, i.e., up to 70 cP (measured at 4° C. at 75 s⁻¹). The viscosities of Creamers 3, 4 and 5 are between 10 and 200% or more higher than the viscosities measured for Creamers 1 and 2.

Table 1 summarizes the measured viscosities and protein denaturation degrees for different Creamer 1 and Creamer 3. Tables 2-3 show the compositions of Creamers 4-5, respectively. It can be clearly seen that the measured increased viscosity in Creamer 3 is not (only) due to an increase in the sugar level, but is mainly related to an increase in the protein denaturation degree. As a comparative example, conventional dairy Creamer 1 (i.e., the DARIGOLD® creamer) exhibits a viscosity of 8 cP (4° C., 75 s⁻¹) at a sucrose/protein ratio of 11.9 and a measured protein denaturation degree of 63%.

TABLE 1
Creamers 1 and 3

| Ingredients | Creamer 1 | Creamer 3 |
|---|---|---|
| % Sugar | 19.70 | 25.00 |
| % Fat | 10.40 | 10.00 |
| % Protein | 1.90 | 2.10 |
| Total CHO % (sucrose + lactose) | 22.60 | 28.00 |
| Mass ratio of sugar/protein | 11.89 | 13.33 |
| Viscosity mPa · s (cP) after heat | 8.00 | 14.00 |
| treatment | | |
| Whey denaturation rate % | 63.00 | 87.00 |

TABLE 2
Creamer 4

| Ingredients | % mass |
|---|---|
| Water | 13.10 |
| Sugar white fine 50 lb Kosher | 20.00 |
| Milk skim fat 0% snf 8.5% LB | 59.50 |
| Rice powder | 2.00 |
| Cream fresh 38% min fat | 5.00 |
| Flavor Vanilla | 0.40 |
| total (%) | 100.00 |

TABLE 3
Creamer 5

| Ingredients | % mass |
|---|---|
| Sugar white fine 50 lb Kosher | 25.00 |
| Milk skim fat 0% snf 8.5% LB | 47.85 |
| Rice powder | 2.00 |
| Cream fresh 38% min fat | 24.75 |
| Flavor Vanilla | 0.40 |
| total (%) | 100.00 |

The denaturation degree of all globular proteins present in the creamer can be measured according to the following method. In milk, the undenatured whey protein nitrogen (serum protein nitrogen (“SPN”)) is defined as the nitrogen that is not precipitated by sodium acetate as described by Rowland (J. Dairy Res. 9 (1938) 42-46), incorporated herein by reference (non-casein nitrogen (“NCN”) minus the non protein nitrogen (“NPN”): SPN=NCN−NPN. The SPN decreases with the intensity of the heat treatment undergone by the proteins.

The denaturation rate described in this method is defined as the percentage of denatured proteins in the total proteins. The principle of the method is the precipitation of denaturated whey proteins and caseins by acetic acid and sodium acetate. Nitrogen (i.e., NCN) is determined in the filtrate by the Kjeldahl method. Precipitation of total proteins is done by 12% trichloroacetic acid. Nitrogen (i.e., NPN) determination in the filtrate is done by the Kjeldahl method. Total nitrogen is determined by the Kjeldahl method.

### Conclusion

The creamers according to embodiments of the present disclosure have denatured proteins in the presence of sugar so that the resulting viscosity in the creamer increases and does not decrease. The final result is a creamer having an improved shelf-life, whitening effect and better sensorial properties.

### Example 2

### Rheology Data of Different Sugar/Protein Model Mixtures

Sample preparation: Skim milk was used as protein and mixed with regular granular sucrose at room temperature using a bench scale Polytron. The protein content in the milk was 3.5% (w/w). Different amounts of sucrose were added to milk in order to get a mass ratio of sugar/total protein ranging from 10.80 to 18.60. The mixture was then heat treated in the rheometer at 80° C. as depicted below.

Rheological Method used: Steady shear experiments were performed using an Anton Paar Physica MCR 501 rheometer equipped with a double gap concentric cylinder geometry. The shear rate was constant at 75 s⁻¹. The non-heat treated protein sugar mixtures were put into the rheometer at room temperature and then cooled down in the rheometer to 4 C. The samples were then heated to 80° C. at a heating rate of 5° C./min and cooled down immediately to 4° C. again at a cooling rate of 5° C./minute. During the heating and cooling step, the samples were sheared at a shear rate of 75 s⁻¹ to assure good heat transfer in the creamer.

Observations: In Table 4 the measured viscosities (given at 4° C.) are summarized before heat treatment and after heat treatment of the samples in the rheometer from 4° C. to 80° C. and back to 4° C. with a heating and cooling rate of 5° C./minute. It shows that, by increasing the sugar:protein mass ratio without heat treating the samples, the viscosity (measured at 75 s⁻¹ and at 4° C.) increases under these conditions from 4 cP (sugar/protein mass ratio of 10.8) to 10.4 cP (sugar/protein mass ratio of 18.6), i.e., by only a factor of 2.6. Heat treatment of the samples at the same sugar to protein mass ratio reveals also a significant, if not even more pronounced increase in viscosity, especially at relatively high sugar/protein mass ratios. While at a relatively low sugar/protein mass ratio, the viscosity increase by a factor of 2.5, it increases similar or more for higher sugar/protein ratios, i.e., for the sample with the sugar/protein ratio of 13.7 by a factor of 2.5, and for the sample of with a sugar/protein ratio of 18.6 by a factor of 6.7. This shows that heat treatment of sugar protein mixtures is an effective way to generate viscosity in the creamers of the present disclosure.

TABLE 4

| Mass ratio | Viscosity (cP)at 4° C. | Viscosity (cP) at 4° C. |
|---|---|---|
| sugar/protein | before heat treatment | after heat treatment |
| 10.8 | 4 | 10 |
| 13.7 | 8 | 20 |
| 18 | 10.5 | 70 |

### Example 3

The following tables show formulations of the creamer according to embodiments of the present disclosure. The mean particle sizes of the oil droplets range between 0.4 and 0.8 microns. Oil droplet size analysis using a Malvern Mastersizer reveal that the creamers consist of similar oil droplet sizes as conventional dairy creamers. The color of the creamers as is and in coffee is measured using a colorimeter HunterLab (Quest) using the Lab scale. The whiteness of the creamers, referred to as the L value, is in the range of 78 to 86. The whiteness of the coffee is ranges between 44 to 52 at a creamer:coffee mass ratio of 1:6.

TABLE 5
Formulation #1 (Viscosity at 4° C. and 75 s⁻¹ = 15.00 cP)

| Ingredients | % mass |
|---|---|
| Sugar white fine 50 lb Kosher | 25.00 |
| Milk skim fat 0% snf 8.5% LB | 50.00 |
| Cream fresh 38% min fat | 24.75 |
| Vanilla PWD flavor | 0.25 |
| total (%) | 100.00 |

TABLE 6
Formulation #2 (Viscosity at 4° C. and 75 s⁻¹ = 42.50 cP)

| Ingredients | % mass |
|---|---|
| Milk skim fat 0% snf 8.5% LB | 30.90 |
| Sweetened Condensed milk | 55.00 |
| Cream fresh 38% min fat | 13.70 |
| Flavor Vanilla powder | 0.40 |
| total (%) | 100.00 |

TABLE 7
Formulation #3 (Viscosity at 4° C. and 75 s⁻¹ = 12.00 cP)

| Ingredients | % mass |
|---|---|
| Water | 13.10 |
| Sugar white fine 50 lb Kosher | 20.00 |
| Milk skim fat 0% snf 8.5% | 59.50 |
| Rice powder | 2.00 |
| Cream fresh 38% min fat | 5.00 |
| Flavor Vanilla | 0.40 |
| total (%) | 100.00 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A creamer comprising a sugar, a fat, a protein having a globular protein denaturation degree of about 75% and about 98%, and a viscosity of about 10 cP and about 70 cP when measured at a temperature of 4° C. and a shear rate of 75 s⁻¹.

2. The creamer of claim 1, wherein the viscosity ranges between about 11 cP and about 40 cP when measured at a temperature of 4° C. and a shear rate of 75 s⁻¹.

3. The creamer of claim 1, wherein the viscosity is about 12 cP and about 16 cP when measured at a temperature of 4° C. and a shear rate of 75 s⁻¹.

4. The creamer of claim 1, wherein the creamer comprises a sugar:protein mass ratio of about 10:1 to about 18:1.

5. The creamer of claim 1, wherein the sugar is from a sugar source selected from the group consisting of beets, canes, condensed milk, honey, molasses, agave syrup, maple syrup, malt, corn, tapioca, potato and combinations thereof.

6. The creamer of claim 1, wherein the protein is from a protein source selected from the group consisting of liquid cow milk, soy milk, heavy cream, buttermilk, chocolate milk, condensed milk, evaporated milk, rice flour, whey protein microgels, soy protein powder, whole milk powder, non fat dry milk powder and combinations thereof.

7. The creamer of claim 1, wherein the fat is from a fat source selected from the group consisting of heavy cream, liquid whole milk, partially defatted liquid milk, whole milk powder, anhydrous milk fat and combinations thereof.

8. The creamer of claim 1 comprising an ingredient selected from the group consisting of flavors, sweeteners, colorants and combinations thereof.

9. A creamer comprising a sugar, a fat, a protein having a globular protein denaturation degree of about 75% and about 98%, and a viscosity ranging of about 7 cP and about 70 cP when measured at a temperature of 20° C. and a shear rate of 75 s⁻¹.

10. A natural dairy creamer comprising about 12% and about 35% by mass of sugar, about 2.5% and about 12% by mass of a fat, about 1% and about 5% by mass of a protein having a globular protein denaturation degree of about 75% and about 98%, and a viscosity ranging of about 10 cP and about 70 cP when measured at a temperature of 4° C. and a shear rate of 75 s⁻¹, wherein the creamer excludes hydrocolloids, synthetic emulsifiers, buffer salts and artificial whitening agents.

11. The natural dairy creamer of claim 10, wherein the viscosity is about 11 cP and about 40 cP.

12. The natural dairy creamer of claim 10, wherein the viscosity ranges between is about 12 cP and about 16 cP.

13. The natural dairy creamer of claim 10, wherein the sugar is from a sugar source selected from the group consisting of beets, canes, condensed milk, honey, molasses, agave syrup, maple syrup, malt, corn, tapioca, potato and combinations thereof.

14. The natural dairy creamer of claim 10, wherein the protein is from a protein source selected from the group consisting of liquid cow milk, soy milk, heavy cream, buttermilk, chocolate milk, condensed milk, evaporated milk, rice flour, whey protein microgels, soy protein powder, whole milk powder, non fat dry milk powder and combinations thereof.

15. The natural dairy creamer of claim 10, wherein the fat is about 4% and 10.5% by mass.

16. The natural dairy creamer of claim 10, wherein the fat is from a fat source selected from the group consisting of heavy cream, liquid whole milk, partially defatted liquid milk, whole milk powder, anhydrous milk fat and combinations thereof.

17. The natural dairy creamer of claim 10 comprising an ingredient selected from the group consisting of flavors, sweeteners, colorants and combinations thereof.

18. A natural dairy creamer comprising about 12% and about 35% by mass of sugar, between about 2.5% and about 12% by mass of a fat, and about 1% and about 5% by mass of a protein having a globular protein denaturation degree of about 75% and about 98%.

19. The natural dairy creamer of claim 18, wherein the creamer does not include hydrocolloids, synthetic emulsifiers, buffer salts and artificial whitening agents

20. The natural dairy creamer of claim 18, wherein the sugar is from a sugar source selected from the group consisting of beets, canes, condensed milk, honey, molasses, agave syrup, maple syrup, malt, corn, tapioca, potato and combinations thereof.

21. The natural dairy creamer of claim 18, wherein the protein is from a protein source selected from the group consisting of liquid cow milk, soy milk, heavy cream, buttermilk, chocolate milk, condensed milk, evaporated milk, rice flour, whey protein microgels, soy protein powder, whole milk powder, non fat dry milk powder and combinations thereof.

22. The natural dairy creamer of claim 18, wherein the fat is from a fat source selected from the group consisting of heavy cream, liquid whole milk, partially defatted liquid milk, whole milk powder, anhydrous milk fat and combinations thereof.

23. A consumable product comprising
at least one component selected from the group consisting of a coffee, tea and cocoa; and
a creamer comprising a sugar, a fat, a protein having a globular protein denaturation degree of about 75% and about 98%, and a viscosity of about 10 cP and about 70 cP when measured at a temperature of 4° C. and a shear rate of 75 s⁻¹.

24. The consumable product of claim 23, wherein the viscosity is about 11 cP and about 40 cP when measured at a temperature of 4° C. and a shear rate of 75 s⁻¹.

25. The consumable product of claim 23, wherein the viscosity is about 12 cP and about 16 cP when measured at a temperature of 4° C. and a shear rate of 75 s⁻¹.

26. The consumable product of claim 23, wherein the sugar is from a sugar source selected from the group consisting of beets, canes, condensed milk, honey, molasses, agave syrup, maple syrup, malt, corn, tapioca, potato and combinations thereof.

27. The consumable product of claim 23, wherein the protein is from a protein source selected from the group consisting of liquid cow milk, soy milk, heavy cream, buttermilk, chocolate milk, condensed milk, evaporated milk, rice flour, whey protein microgels, soy protein powder, whole milk powder, non fat dry milk powder and combinations thereof.

28. The consumable product of claim 23, wherein the fat comprises about 4% and 10.5% by mass.

29. The consumable product of claim 23, wherein the fat is from a fat source selected from the group consisting of heavy cream, liquid whole milk, partially defatted liquid milk, whole milk powder, anhydrous milk fat and combinations thereof.

30. A method of making a creamer, the method comprising:
combining a fat, a sugar and a protein to form a mixture having a sugar:protein mass ratio of about 10:1 to about 18:1; and
heating the mixture at a suitable temperature to achieve a globular protein denaturation degree of about 75% and about 98% in the mixture to form the creamer, wherein the creamer has a viscosity of about 10 cP and about 70 cP when measured at a temperature of 4° C. and a shear rate of 75 s⁻¹.

31. The method of claim 30 comprising homogenizing and aseptically processing the creamer.

32. The method of claim 30, wherein the creamer does not include any hydrocolloids, synthetic emulsifiers, buffer salts and artificial whitening agents.

33. A method of making a dairy creamer having a whitening effect, the method comprising:
combining a sugar, a dairy source having a fat, and a dairy source having a protein to form a dairy mixture having a sugar:protein mass ratio ranging from about 10:1 to about 18:1;
heating the dairy mixture at a suitable temperature to achieve a globular protein denaturation degree of about 75% and about 98% in the dairy mixture to form the dairy creamer, wherein the dairy creamer has a viscosity of about 10 cP and about 70 cP when measured at a temperature of 4° C. and a shear rate of 75 s⁻¹; and
ultra high temperature sterilizing the dairy creamer.

34. The method of claim 33, wherein the suitable temperature ranges is about 45° C. to about 85° C.

35. The method of claim 33, wherein the dairy source having the fat and the dairy source having the protein are pasteurized before being combined with the sugar.

36. The method of claim 33, wherein the dairy creamer does not include any hydrocolloids, synthetic emulsifiers, buffer salts and artificial whitening agents.
